(19) United States
(12) Patent Application Publication
(10) Pub. No.: US 2025/0153417 A1
(43) Pub. Date: May 15, 2025

(54) METHOD AND APPARATUS FOR MOLDING AND COATING A CONTAINER COMPRISING FIBERS

(71) Applicant: Krones AG, Neutraubling (DE)

(72) Inventors: Jörg Zacharias, Koefering (DE); Yvette Freese, Regensburg (DE); Robert Aumer, Woerth a. d. Donau (DE); Andreas Hippel, Wörth an der Donau (DE)

(21) Appl. No.: 18/938,936

(22) Filed: Nov. 6, 2024

(30) Foreign Application Priority Data
Nov. 10, 2023 (DE) 102023131286.3

(51) Int. Cl. B29C 49/24; B29C 49/42; B29C 49/46; B29K 711/12; B29L 31/00; D21J 1/08; D21J 3/10

(52) U.S. Cl. CPC B29C 49/2408; B29C 49/42817; B29C 49/46; D21J 1/08; D21J 3/10; B29C 2049/2404; B29C 2049/4664; B29K 2711/12; B29K 2995/006; B29K 2995/0067; B29L 2031/7158

(57) ABSTRACT

The disclosure relates to a method for molding and coating a container comprising fibers, in particular pulp, wherein the method comprises: molding a container comprising fibers, in particular pulp, which container comprises an opening, wherein the container is provided in a mold and in particular is molded around a coating bladder, or molding container elements comprising fibers, in particular pulp, which container elements comprise an opening, wherein the container elements are provided in a mold and in particular are molded around a coating bladder; molding the coating bladder, which is arranged at least temporarily and/or partially in the container or the container elements; applying a pressure medium from a pressure source to the coating bladder to expand it, so that the coating bladder is at least partially applied to an inner wall of the container or the container elements.

### CROSS REFERENCE TO RELATED APPLICATION

The present application claims priority to German Patent Application No. 10 2023 131 286.3 filed on Nov. 10, 2023. The entire contents of the above-listed application are hereby incorporated by reference for all purposes.

### TECHNICAL FIELD

The present disclosure relates to a method and an apparatus for molding and coating a container comprising fibers.

### BACKGROUND

Methods are known from the prior art in which a bladder is used for the drying step of a wet molded article made of pulp in order to keep the molded article in shape and to press it smooth. This is usually done during the drying step in order to minimize shrinkage during drying of the pulp container.

### SUMMARY

The inner wall of the pulp container is then coated to minimize the water impermeability and the permeation of gases and water vapor through the container. To improve the processability of the coating material, it is typically sprayed onto the inner wall of the pulp container at over 100° C. A disadvantage of the prior art method is that, after the bladder has been subjected to pressure in order to press it against the inside of the container during or before the drying process, it must be released from excess pressure again in order to subsequently pull it out of the container. In addition, a separate bladder must be kept for each version, which makes format changes complex.

In a further step, the coating is now applied to the inner wall of the pulp container, for which at least the coating material is heated.

Pulling out the bladder, heating the coating of the containers and spraying the inside with the coating material increases the energy and time required for the pulp container manufacturing process.

Proceeding from this, the present disclosure is based on the object of providing a method and an apparatus for molding and coating a container comprising fibers, which allows containers comprising fibers to be manufactured in a more time-and energy-efficient manner compared to the prior art.

The object is achieved by a method as described herein.

In the following, the term container refers both to a complete container and to a plurality of individual container elements.

The fibers are in particular at least partly plant fibers, for example cellulose. Pulp may comprise a suspension of water and fibers. The fibers can comprise lignin, banana leaves, quinine, glass fibers, metallic threads, wood pulp fibers, hemp, sisal, linters, silphium, wheat and/or surgical threads. The fibers can comprise, for example, fibers from coniferous woods, leafy woods, and/or sycamores, and/or from grasses, reeds, and/or bamboo, or the like. Lignin can have a supportive effect on the cellulose and may also be suitable for transparent applications. Banana leaves can be suitable for larger containers, such as single use tableware. An improvement in the strength can be achieved by embedding glass fibers, metal threads and/or sutures.

With the method, the coating bladder remains in the container after molding the container, in particular after the container wall has been pressed flat and compressed, as a coating on the inner wall of the container. This eliminates the need to release excess pressure, then pull out the bladder after the molding step and the additional coating step. The coating bladder is thus used twice and the molding and coating processes can take place simultaneously. This allows the manufacturing process of the containers containing fibers to be carried out in a more time-and energy-efficient manner.

In a further embodiment, the method may further comprise: increasing the temperature of at least one region of the container and at least one region of the coating bladder, thereby at least partially drying the container and at least partially adapting the coating bladder to the container, and optionally at least partially connecting the coating bladder to the inner wall of the container.

Since the coating bladder is used for both molding and coating in the container, the container and the coating bladder can be heated together, whereby the container can be dried and the coating bladder can be brought to processing temperature. This saves energy and time when manufacturing the coated containers, as any temperature increases for drying and coating can be combined.

Furthermore, as a result of the high temperatures, the coating bladder can stick to the inner wall of the container, which can increase the stability and resilience of the container. In particular, the coating bladder is bonded to the container or container elements in such a way that the two components can be separated for recycling.

Alternatively, the coating bladder can also be secured against slipping relative to the container by notches in the container. By placing the coating bladder on the notch in the container, a positive connection is created.

In an alternative embodiment, the coating bladder can be applied only to the inner wall of the container, in particular if the materials of the coating bladder and the container cannot be recycled together or can only be recycled with great effort, so that the separation of the layers for recycling the container is facilitated.

In a further embodiment, a biodegradable material, in particular PLA, PBAT, PHA; PHBH, cellulose-based polymers, starch polymers, protein-based polymers, lignin-based polymers or natural rubber, or a plastics material, in particular PEF, PE, PET, HDPE, PVOH or EVOH, or a mixture of the materials mentioned can be used as the material for the coating bladder. This can reduce the environmental impact of the container, in particular in the case of improper disposal. In addition, recycling of the container can be made easier. In particular, the coating bladder can be designed as a multi-layer structure in order to achieve increased resistance to thermal and/or mechanical stress.

In addition, if the material of the container is made of ecologically degradable fibers (as mentioned above), such a container, which consists, for example, of ecological fibers for the basic structure and ecologically degradable material for the coating, can be recycled or biodegraded in one step in an environmentally friendly manner.

In a further embodiment, the coating bladder can be applied in such a way that the coating bladder has less than 25%, in particular less than 10%, of the weight of the container.

Alternatively, the coating bladder can be applied in such a way that the wall thickness of the coating bladder after expansion is at least partially less than 20%, in particular less than 10%, of the wall thickness of the container.

Here, the wall thicknesses of the coating bladder and the container are compared in the region where the coating bladder rests against the container.

With such a wall thickness of the coating bladder, the fiber-containing material of the container can be sealed watertight on the inside. At the same time, the mass of the container is not excessively increased by the coating bladder or the resulting coating layer and less coating material is consumed.

In a further embodiment, the coating bladder can be subjected to an overpressure of at least 50,000 Pa (0.5 bar), in particular between 1,000,000 Pa (10 bar) 4,000,000 Pa (40 bar), so that the container can be molded with corresponding counterpressure and the coating bladder is pressed against the inner wall of the container so that the inner wall of the container is pressed smooth. It is also possible to compress the wall thickness of the container in such a way that the moisture is at least partially pressed out of the container, thereby reducing the residual moisture content of the container.

In a further embodiment, the temperature of at least one region of the container and at least one region of the coating bladder can be increased by means of hot air, steam, infrared radiation, microwave radiation, induction, or heat transfer through a fluid or thermocouple so that regions of the container can be dried in an energy-efficient manner and regions of the coating bladder can be brought to processing temperature in an energy-efficient manner.

In a further embodiment, the temperature of at least one region of the container can be increased such that the container is at least partially dried to below 20% residual moisture content, in particular below 10% residual moisture content, in order to produce a dimensionally stable and durable container. The overpressure with which the coating bladder presses against the inner wall of the container during drying can prevent the container from shrinking.

In a further embodiment, the temperature of at least one region of the coating bladder can be increased at least temporarily to between 20° C. and 250° C., in particular to between 100° C. and 200° C. This means that the coating bladder is more stretchable, easy to process and adapts to the inner wall of the container when applied.

In a further embodiment, a gas, in particular air, or a liquid, in particular water or the product to be packaged in the container, can be used as the pressure medium. In particular, when the product to be packaged is used as the pressure medium, the filling process step can be applied with the application of the coating bladder, making the manufacturing process more efficient.

In a further embodiment, the method may comprise molding container elements comprising fibers, in particular pulp, which elements comprise an opening, wherein the container elements are provided in a mold and in particular are molded around a coating bladder, wherein the individual container elements are joined together by the coating bladder. This increases the flexibility in molding the containers.

This object is also achieved by an apparatus according to claim 11.

The apparatus is designed such that the coating bladder can be separated after pressure has been applied to mold the container and can remain in the container as a coating on the inner wall of the container. This eliminates the need to release pressure from the coating bladder and then pull the bladder out after molding. The coating bladder can thus be used twice, and the molding and coating processes can take place simultaneously. This means that the apparatus can be used to manufacture containers containing fibers in a more time- and energy-efficient manner.

According to a further embodiment, the apparatus can further comprise: a drying device for increasing the temperature of at least one region of the container and at least one region of the coating bladder, wherein the drying device can be designed such that the container can be at least partially dried and the coating bladder can at least partially adapt to the inner wall of the container, and in particular the coating bladder can at least partially form a connection with the inner wall of the container.

Since the coating bladder can be used for both molding and coating in the container, the container and the coating bladder can be heated together with the drying device, whereby the container can be dried and the coating bladder can be brought to processing temperature. This saves energy and time when manufacturing the coated container, as any temperature increases for drying and coating can be combined.

According to a further embodiment, the coating device can be designed such that the coating bladder can be subjected to an overpressure of at least 50,000 Pa (0.5 bar), in particular between 1,000,000 Pa (10 bar) and 4,000,000 Pa (40 bar), so that the container can be molded with corresponding counterpressure and the coating bladder can be pressed against the inner wall of the container so that the inner wall of the container can be flattened. It is also possible that the wall thickness of the container is compressed in such a way that the moisture can be at least partially pressed out of the container, thereby reducing the residual moisture content of the container.

According to a further embodiment, the drying device can be designed such that the temperature of at least one region of the container and at least one region of the coating bladder can be increased by means of hot air, steam, infrared radiation, microwave radiation, induction, or heat transfer through a fluid or thermocouple, so that at least regions of the container and the coating bladder can be dried or brought to processing temperature in an energy-efficient manner.

In a further embodiment, the coating device can be designed such that different container elements are joined together by means of the coating bladder. This increases the flexibility in molding the containers.

The disclosure is described in more detail below with reference to the figures by means of embodiments. Individual features of the respective embodiments can be combined to achieve new designs.

### BRIEF DESCRIPTION OF THE FIGURES

FIG. 1 shows an apparatus according to a first embodiment.

FIGS. 2A to 2F show method steps for molding and coating a container with an apparatus according to a first embodiment.

FIGS. 3A to 3C show different embodiments of a coating bladder.

### DETAILED DESCRIPTION

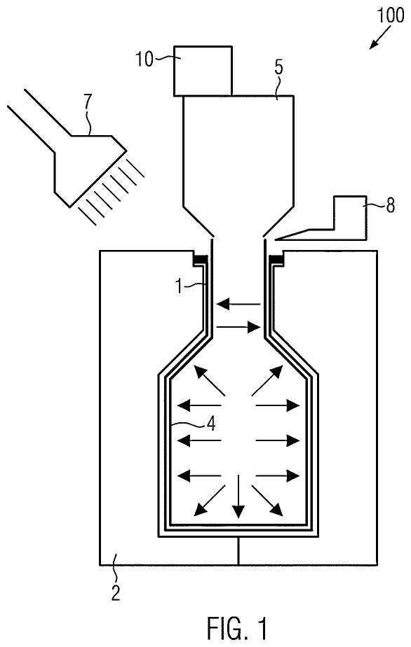

FIG. 1 shows an apparatus 100 comprising a mold 2 in which the container 1 is to be at least partially molded. The mold 2 can be made up of two or more parts. To apply pressure to the coating bladder 4, the apparatus 100 further comprises a coating device 5 and a pressure source 10, in particular a pump or a compressor and a separating device 8. The pressure source 10 can be designed such that a maximum overpressure of at least 50,000 Pa (0.5 bar), in particular at least 1,000,000 Pa (10 bar), can be generated.

In addition, the apparatus 100 can comprise a drying device 7 with which the temperature of the container 1 and the coating bladder 4 can be at least partially increased.

The drying device 7 can provide the heat in particular by means of hot air, steam, infrared radiation, microwave radiation, induction, heat transfer through a fluid or thermocouple.

The separating device 8 can mechanically separate the coating bladder 4 from the coating device 5, as shown in FIG. 1E. The separating device 8 can be designed with sharp edges and, in particular, can be pivoted or retracted in order to separate or cut off the coating bladder 4 from the coating device 5 after the coating bladder 4 has been introduced into the container 1 and pressurized.

The separating device 8 can be designed in two parts, wherein two mechanical separating elements, in particular with sharp edges, can move toward each other in order to separate or cut off the coating bladder 4 from the coating device 5.

The separating device 8 can also be designed as a thermal element. Thus, the coating bladder 4 can be heated locally in such a way that the coating bladder 4 melts at the heated point and the coating bladder 4 is separated from the coating unit 5.

Furthermore, the separating device 8 can also separate the coating bladder 4 from the coating unit 5 by moving away the coating device 5 or the mold 2 or container 1. With the aid of the apparatus 100, the method can be carried out as follows:

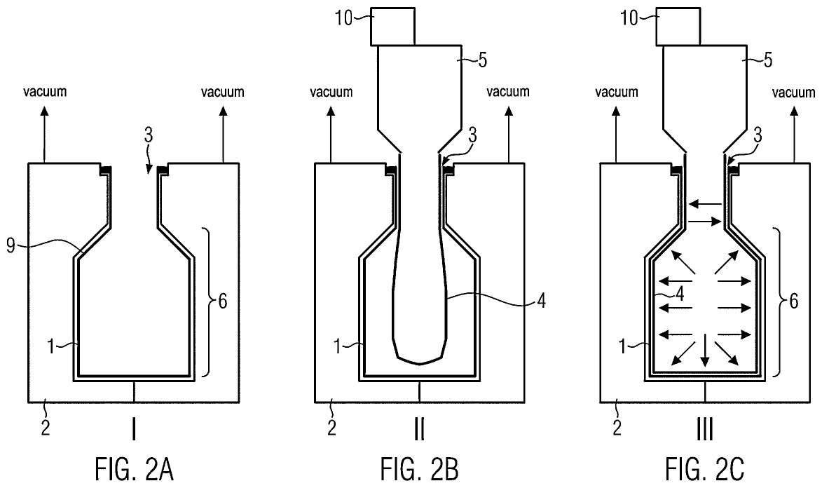

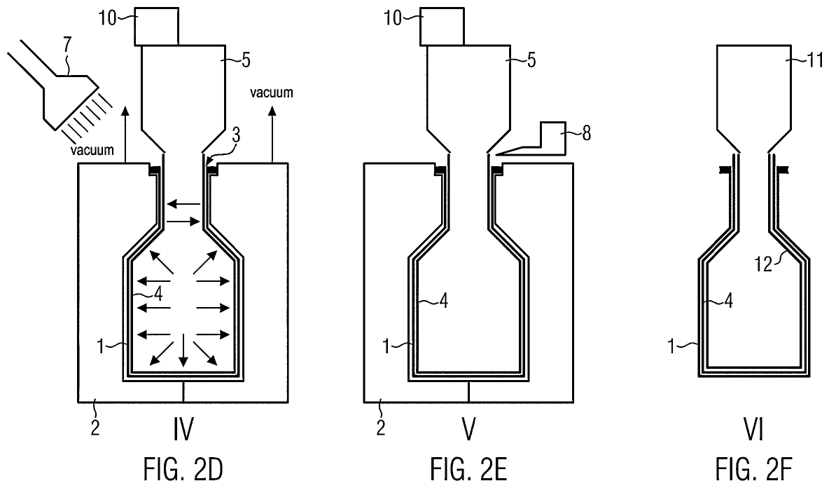

In the first method step I (FIG. 2A), the container 1 is at least partially molded within the mold 2 and comprises an opening 3. The mold 2 can in particular be designed in two parts or in multiple parts, so that a container 1 which has an undercut 9, in particular through a region of the opening 3 of the container 1 which is tapered compared to the main body 6 of the container 1, can also be removed from the mold 2 without damaging the mold 2 or the container 1. Furthermore, the container 1 in the first method step I can consist of a pulp-containing material with a residual moisture content of more than 20%.

The container 1 can be formed in the mold 2 with the opening 3 facing upward but also upside down or in another orientation.

In method step II (FIG. 2B), the coating bladder 4 can now be formed within the container 1 using the coating device 5 or introduced into the container 1 through the opening 3. The material for forming the coating bladder 4 can, for example, be present as a thin film/foil or as a liquid and consists in particular of a biodegradable material, such as Ecovio, PLA, PBAT, PHA, PHBH, cellulose-based polymers, starch-based polymers, protein-based polymers, lignin-based polymers, natural rubber or basic materials such as PEF, PE, HDPE, PVOH and EVOH.

If the coating bladder 4 is introduced into the container 1 through the opening 3, the coating bladder is designed in particular such that it fits through the opening 3 in the pressure-free state (no overpressure or overpressure greater than 50,000 Pa (0.5 bar) inside the coating bladder 4).

In method step III, which is shown in FIG. 2C, the coating bladder 4 is now subjected to a pressure medium by means of a pressure source 10 in order to expand it, so that the coating bladder at least partially adheres to the inner wall of the container. The overpressure within the coating bladder 4 is shown in FIG. 2C with arrows pointing toward the inner wall of the container 1, and is in particular at least 50,000 Pa (0.5 bar), in particular at least 1,000,000 Pa (10 bar), so that the coating bladder 4 presses the container 1 against the mold 2 or can compress its wall thickness. In this way, the inner surface of the container 1 can be smoothed. The coating bladder 4 can also compress the wall thickness of the container 1 in such a way that the liquid is pressed out of the material of the container 1, in particular pulp-containing material. In this way, the residual moisture content of the container 1 can be reduced to below 20%, in particular below 10%, so that further drying of container 1 is not necessary.

In particular, a gas, such as air, or a liquid, such as water or the product to be filled into the container, 1 can be used as the pressure medium. If the product to be filled into the container 1 is already used as the pressure medium, no additional filling process is required and the manufacturing of the containers and subsequent packaging of the product can be carried out more efficiently.

In addition, the coating bladder 4 can be designed in such a way that, in the event of an overpressure which is transferred by the pressure medium from the pressure source 10 to the coating bladder 4, it initially rests against the inner wall of the container 1 in a lower region 6 of the container before the coating bladder 4 also rests against the inner wall of the container 1 in the region of the opening 3. This can prevent inclusions, in particular of the air previously present in the container 1, from forming within the wall thickness of the container 1.

In particular, the coating bladder 4 can be pressurized in such a way that the wall thickness of the coating bladder is less than 20% of the wall thickness of the corresponding portion of the container 1 against which the coating bladder 4 rests.

In an optional method step IV, shown in FIG. 2D, the temperature of the container 1 and the coating bladder 4 can be increased. As indicated by the arrows in FIG. 2D in the direction of the inside of the container 1, the coating bladder 4 is subjected to pressure via the pressure source 10 during heating or increasing of the temperature.

With the increased temperature, the container 1 can be dried, in particular to a residual moisture content of less than 20%, in particular 1-10%. The drying process can increase the stability and dimensional accuracy of the container 1. Since the coating bladder 4 is pressurized during the optional drying process, shrinkage of the container 1 during the drying process is counteracted. This ensures that the container is manufactured with precise dimensions.

In addition, the at least partially increased temperature, in particular to between 100° C. and 200° C., can cause the coating bladder 4 to stick to the inner wall of the container 1, so that the coated container 4 is more stable and resilient.

Alternatively, it is also possible to keep the temperatures lower. In this way, the coating bladder 4 only adheres to the inner wall of the container 1 and the coating bladder 4 is prevented from sticking to the container 1. This method is particularly applicable if one of the materials of the coating bladder 4 or the container 1 is not biodegradable and the two layers can be separated during recycling.

Various heat sources such as hot air or steam, infrared, microwave radiation, induction, a heat transfer fluid or thermocouple can be used to increase the temperature. FIG. 2D schematically shows an infrared lamp for increasing the temperature of at least one region of the container or coating bladder.

In method step V (FIG. 2E), the coating bladder 4, which has at least partially adhered to the inner wall of the container 1, is now separated from the coating device 5 or the pressure source 10 by the separating device 8, so that the coating bladder 4 remains as a coating in the container 1.

Furthermore, as shown in the optional method step VI of FIG. 2F, at least one additional coating step can take place in addition to the coating bladder 4 already introduced into the container 1 for applying at least one additional coating. The additional coating can have a maximum thickness of 1.0 mm, in particular a maximum of 0.000001 mm. The additional coating can be applied to the coating bladder 4 as an additional coating bladder 12, for example with an additional coating device 11, so that the additional coating faces the inside of the container. The additional coating bladder 12 can alternatively also be applied by the coating device 5, with which in particular the coating bladder 4 can also be introduced into the container 1 and subjected to pressure.

The additional coating bladder 12 can be separated from the additional coating device 5 or alternatively the coating device 5 by the separating device 8 or an additional separating device (not shown) mechanically, thermally or by moving away the additional coating device 5 or alternatively the coating device 5.

It is also conceivable that the temperature of the container 1 and of the additional coating, which is introduced into the container 1, for example in the form of an additional coating bladder 12, is increased by the drying device 7. This can make it easier to apply the additional coating.

Embodiments are conceivable in which the additional coating is, for example, sprayed on or otherwise applied so that the additional coating faces the inside of the container 1. The additional coating can in particular consist of a material which minimizes the gas permeability of the coated container 1, in particular SiOx, and in particular can be formed in a thickness of between 0.000015 mm and 0.00002 mm.

Alternatively, the additional coating can also be applied using plasma coating. For this purpose, a treatment device (not shown) can introduce a gas into the interior of the container 1. A gas suitable for the plasma process can be introduced into the container 1 and distributed as homogeneously as possible inside the container. In particular, the gas introduced into the interior of the container 1 can be ignited so that a plasma is created. For this purpose, for example, an electrode can be introduced into the container 1. The energy that is to ignite the plasma can then be introduced in the form of high frequency via this electrode. In particular, this gas can be a mixture of a silicon-containing precursor and oxygen, in particular for PECVD (=plasma enhanced chemical vapor deposition) with silicon oxide. However, other gases are also conceivable, for example acetylene for the deposition of so-called DLC layers.

With the additional coating, the gas permeation of the container 1 can be reduced, thereby achieving a longer shelf life of the liquids/foodstuffs stored in the container. At the same time, such an additional coating can keep the total weight proportion of the coatings below 10%, in particular below 5%, thus facilitating recycling.

FIG. 2F shows an implementation of method step VI in which the container 1 has already been removed from the mold 2. However, method step VI can also be carried out while the container 1 is still in the mold 2.

As an alternative embodiment, it is also possible for the container 1 to be transferred by means of the coating bladder 4 with only a slight internal pressure below 10,000 Pa (10 bar) or by means of another device (not shown) to a second mold (not shown), in particular with a smoother surface than the first mold 2, in which the container 1 can be molded and/or dried.

The second mold can in particular be preheated or heated continuously, whereby the energy-intensive heating of the mold 2 for drying the container 1 and applying the coating bladder 4 can be dispensed with.

Furthermore, the mold 2 can be heated during the molding of the container 1, so that the mold 2 can have a higher temperature than the container 1 in order to dry the container 1. The mold 2 can be heated to up to 500° C., in particular up to 250° C. The containers 1 can be pre-dried or completely dried by means of a mold 2 heated in this way. The residual moisture content of the container can be reduced from up to 90% to a residual moisture content of between 10% and 30% for pre-drying and to a residual moisture content of between 5% and 10% for complete drying. During the drying process, free water can be removed by compression and water bound in the fibers of the container 1 can be removed by the increased temperature of the mold 2.

In addition, the mold 2 can be porous and have vacuum channels. Thus, the mold 2 can be subjected to a vacuum (as shown in FIG. 2A to 2D), whereby the free water/water vapor released during the molding and/or drying process can be sucked away.

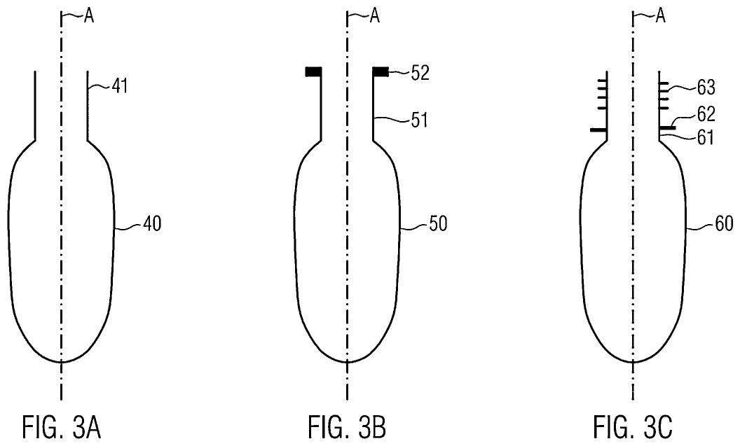

According to one embodiment, as shown in FIG. 3A, the coating bladder 40 can be designed in the mouth region 41 to the mouth of the container (not shown) without further fastening means (not shown). In a further step, a fastening means for a closure (not shown) can additionally be bonded to the mouth region of the bladder 41, or the closure, for example a cap (with or without thread) and/or a seal, is attached directly to the container.

According to one embodiment, the coating bladder 50 may have a lip 52 in the mouth region 51, as shown in FIG. 3B. With the aid of the lip 52, the coating bladder 50 can be connected to the mouthpiece of a container (not shown) in a watertight manner in the axial direction of the longitudinal axis A. Furthermore, it is possible for a closure to be connected directly to the lip 52 of the coating bladder 50, thus creating a watertight cover so that the container, in particular made of pulp-containing material, does not come into contact with the liquid in the coating bladder 50.

As shown in FIG. 3C, the coating bladder 60 can have in particular a thread 63 and a closure ring/support ring 62 in the mouth region 61. With the aid of the thread 63, the coating bladder 60 can be connected to a closure in a watertight manner. The closure ring/support ring 62 can serve as a stop for the closure that can be screwed onto the thread. Moreover, the coating bladder 60 may be transported with or without a container (not shown) surrounding the coating bladder 60.

As an alternative embodiment, a plurality of container elements can be molded first and then joined together using the coating bladder. By designing the container in multiple parts, even more complex geometries can be manufactured with comparatively simple molds. At the same time, the coating bladder seals the individual container elements to each other in an airtight and/or watertight manner.

In another alternative embodiment, the coating bladder may be introduced into the mold before the container is molded. In this case, the fibers, in particular pulp, are flowed around the coating bladder and the container is then molded and coated. This makes the manufacturing process more flexible.

1. A method for molding and coating a container comprising fibers wherein the method comprises:
molding a container comprising fibers, which container comprises an opening, wherein the container is provided in a mold, or
molding container elements comprising fibers, which container elements comprise an opening, wherein the container elements are provided in a mold,
molding a coating bladder which is at least temporarily and/or partially surrounded by the container or the container elements,
applying a pressure medium from a pressure source to the coating bladder to expand it, so that the coating bladder is at least partially applied to an inner wall of the container or the container elements and optionally at least partially compressing the wall thickness of the container, and
separating the coating bladder from the pressure source, while the coating bladder remains at least partially as a container coating in the container or the container elements.

2. The method according to claim 1, wherein a biodegradable material, or a plastics material, or a mixture of the said materials, is used as material for the coating bladder.

3. The method according to claim 1, wherein the coating bladder is applied in such a way that the coating bladder has less than 25% of the weight of the container or the container parts.

4. The method according to claim 1, wherein the coating bladder is subjected to an overpressure of at least 50,000 Pa.

5. The method according to claim 1, wherein the method further comprises:
increasing the temperature of at least a region of the container or the container elements and at least a region of the coating bladder, thereby at least partially drying the container or the container elements and at least partially adapting the coating bladder to the container or the container elements, and optionally at least partially connecting the coating bladder to the inner wall of the container or the container elements.

6. The method according to claim 5, wherein the temperature of at least one region of the container or the container elements and at least one region of the coating bladder is increased by means of hot air, steam, infrared radiation, microwave radiation, induction, or heat transfer through a fluid or a thermocouple.

7. The method according to claim 5, wherein the temperature of at least one region of the container or of the container elements is increased such that the container is at least partially dried to below 20% residual moisture content.

8. The method according to claim 2, wherein the temperature of at least one region of the coating bladder is at least temporarily increased to between 20° C. and 250° C.

9. The method according to claim 1, wherein a gas, or a liquid, is used as the pressure medium.

10. The method according to claim 1, wherein the method comprises molding container elements comprising fibers, which elements comprise an opening, wherein the container elements are provided in a mold and are molded around a coating bladder, and the individual container elements are joined together by the coating bladder.

11. An apparatus for molding and coating a container containing fibers, or container elements comprising an opening, wherein the apparatus comprises:
a mold in which the container or container elements are to be at least partially formed,
a coating device for molding a coating bladder and a pressure source and for applying a pressure medium to the coating bladder to expand it, so that the coating bladder at least partially rests against an inner wall of the container or the container elements and the coating bladder at least partially compresses a wall thickness of the container or the container elements, and
a separating device for separating the coating bladder from the pressure source while the coating bladder remains as a coating in the container or the container elements.

12. The apparatus according to claim 11, wherein the coating device is designed such that the coating bladder is subjected to an overpressure of at least 50,000 Pa.

13. The apparatus according to claim 12, wherein the apparatus further comprises:
a drying device for increasing the temperature of at least one region of the container or the container elements and at least one region of the coating bladder, wherein the drying device is designed such that the container or the container elements are at least partially dried and the coating bladder at least partially adapts to the inner wall of the container or the container elements, and the coating bladder at least partially forms a connection with the inner wall of the container or the container elements.

14. The apparatus according to claim 13, wherein the drying device is designed such that the temperature of at least one region of the container or the container elements and at least one region of the coating bladder is increased by means of hot air, steam, infrared radiation, microwave radiation, induction, or heat transfer through a fluid or thermocouple.

15. The apparatus according to claim 11, wherein the coating device is designed such that different container elements are joined together by means of the coating bladder.

16. The method according to claim 1, wherein fibers comprise pulp.

17. The method according to claim 2 wherein biodegradable material includes PLA, PBAT, PHA; PHBH, cellulose-based polymers, starch polymers, protein-based polymers, lignin-based polymers or natural rubber.

18. The method according to claim 2, wherein plastics material comprises PEF, PE, PET, HDPE, PVOH or EVOH, or a mixture of the said materials.

19. The method according to claim 9, wherein the gas comprises air.

20. The method according to claim 9, wherein the liquid comprises water or the product to be packaged in the container.
